(19) United States
(12) Patent Application Publication
(10) Pub. No.: US 2026/0315874 A1
(43) Pub. Date: Oct. 15, 2026

(54) EXERCISE EQUIPMENT WITH TRAINING PROTOCOL GENERATION

(71) Applicant: OxeFit, Inc., Plano, TX (US)

(72) Inventors: Peter Neuhaus, Pensacola Beach, FL (US); Jin Ye Luo, Coppell, TX (US); Tianyu Cui, Plano, TX (US); Jesse Sweetland, Plano, TX (US); Chantel Coleman, Plano, TX (US); Mohammed Shanableh, Plano, TX (US)

(73) Assignee: OxeFit, Inc., Plano, TX (US)

(21) Appl. No.: 19/636,069

(22) Filed: Apr. 1, 2026

Related U.S. Application Data
(60) Provisional application No. 63/786,483, filed on Apr. 10, 2025.

(51) Int. Cl. A63B 24/00; A63B 21/00; A63B 21/005

(52) U.S. Cl. CPC A63B 24/0075; A63B 21/0058; A63B 21/151; A63B 24/0062; A63B 2024/0065; A63B 2024/0078

(57) ABSTRACT

Fitness equipment includes a motor, a cable coupled to the motor, an exercise implement configured to be coupled to the cable, and a control system. The control system is configured to control the motor to exert a force on the exercise implement via the cable in accordance with an evaluation workout, an initial training protocol for a plurality of weeks, and a customized training protocol after the plurality of weeks. The initial training protocol is generated by the control system based on (i) user performance during the evaluation workout and (ii) a heuristic constraint. The customized training protocol is generated by the control system without requiring compliance with the heuristic constraint.

### CROSS-REFERENCE TO RELATED APPLICATIONS

This application claims the benefit of and priority to U.S. Provisional Application No. 63/786,483, filed Apr. 10, 2025, the entire disclosure of which is incorporated by reference herein in its entirety.

### BACKGROUND

Aspects of the present application relate to exercise equipment, for example strength training equipment. Traditional strength training equipment uses dead weight (plates, barbells, dumbbells, kettlebells, heavy objects, etc.) which can be lifted, moved, etc. by users to complete exercises. Such strength training equipment is not capable of providing any guidance on what training protocols (combinations of exercises and workouts over time) should be performed by users. Many gym users are left with unstructured workouts and do not make substantial progress, especially if such gym users do not have access to a personal trainer.

### SUMMARY

One implementation of the present disclosure is fitness equipment. The fitness equipment includes a motor, a cable coupled to the motor, an exercise implement configured to be coupled to the cable, and a control system. The control system is configured to control the motor to exert a force on the exercise implement via the cable in accordance with an evaluation workout, an initial training protocol for a plurality of weeks, and a customized training protocol after the plurality of weeks. The initial training protocol is generated by the control system based on (i) user performance during the evaluation workout and (ii) a heuristic constraint. The customized training protocol is generated by the control system without requiring compliance with the heuristic constraint.

### BRIEF DESCRIPTION OF THE FIGURES

FIG. 1 is a perspective view of exercise equipment, according to some embodiments.

FIG. 2 is a perspective view of exercise equipment, according to some embodiments.

FIG. 3 is a block diagram of a control system that can be included with exercise equipment, according to some embodiments.

FIG. 4 is a flowchart of a process that can be executed by the control system of FIG. 3, according to some embodiments.

FIG. 5 is a flowchart of another process that can be executed by the control system of FIG. 3, according to some embodiments.

FIG. 6 is an illustration of a first graphical user interface that can be displayed on a display screen of exercise equipment, according to some embodiments.

FIG. 7 is an illustration of a second graphical user interface that can be displayed on a display screen of exercise equipment, according to some embodiments.

FIG. 8 is an illustration of a third graphical user interface that can be displayed on a display screen of exercise equipment, according to some embodiments.

FIG. 9 is an illustration of a fourth graphical user interface that can be displayed on a display screen of exercise equipment, according to some embodiments.

FIG. 10 is an illustration of a fifth graphical user interface that can be displayed on a display screen of exercise equipment, according to some embodiments.

FIG. 11 is an illustration of a set of graphical user interfaces that can be displayed on a display screen of exercise equipment, according to some embodiments.

FIG. 12 is an illustration of another set of graphical user interface that can be displayed on a display screen of exercise equipment, according to some embodiments.

FIG. 13 is an illustration of a sixth graphical user interface that can be displayed on a display screen of exercise equipment, according to some embodiments.

### DETAILED DESCRIPTION

Referring generally to the figures, fitness equipment including an exercise apparatus and methods relating thereto are shown. In particular, an exercise apparatus configured as a motorized strength training apparatus is shown. In the fitness equipment (e.g., motorized strength training apparatuses) described herein, an electric motor operates to generate a tension in a cable. An exercise implement such as a handle, bar, etc. can be connected to the cable such that the tension is communicated to the exercise implement and a force is exerted on a user holding (or otherwise in contact with) the exercise implement. The force experienced by the user performing an exercise can thus be electronically controlled.

Electronic control of the force experienced by the user provides a wide variety of benefits. One benefit may be the opportunity to provide customized training protocols which are adapted to measured user performance and which can be automatically improved by learning from changes in user fitness levels exhibited by such user performance. However, a challenge exists in creating and implementing custom training protocols.

The present disclosure relates to innovation related to controlling fitness equipment in accordance with training protocols generated automatically for users. As will be apparent from the description below, one advantage of the teachings herein is the ability to provide an initial training protocol based on a relatively-short evaluation workout during which the user performs exercises. The initial training protocol can be partially based on user performance during the evaluation workout while being constrained by heuristics (e.g., expert rules) associated with established knowledge on effective training. The initial training protocol can be provided for a period of several weeks, creating a robust set of user performance data and building user trust with automated training protocol generation. Once the user completes a sufficient amount of the initial training protocol, and based on the robust set of user performance data collected, automated generation of a customized training protocol can be provided without requiring compliance with the heuristic constraints (e.g., expert rules) used for the initial training protocol. This staged reduction of heuristic constraints can provide effective, user-adapted training through the initial training protocol and time period while then opening up freedom for the technologies described herein to provide more bespoke, tailored exercise solutions once a robust set of user data is available. The teachings herein thus provide technical solutions to challenges related to collection and processing of robust training data, and are deployed for purposes of controlling operations of motors or other force production or resistance systems for exercise equipment.

These and other technical features and advantages are described in detail in the following passages.

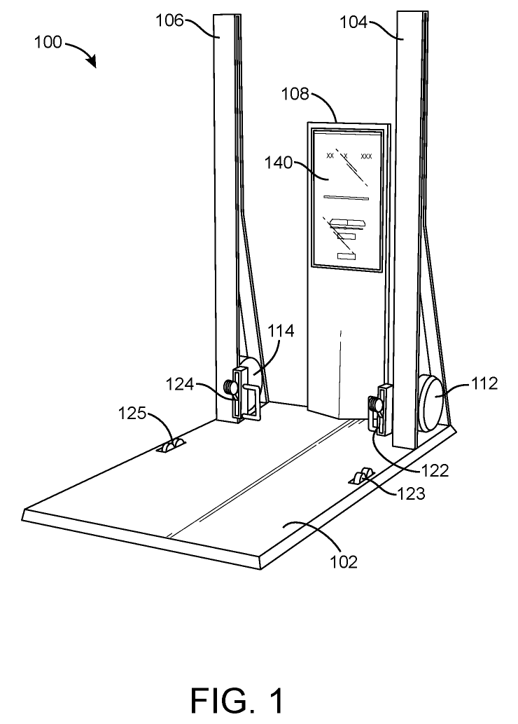

Referring now to FIG. 1, exercise equipment (referred to herein as first exercise equipment 100) is shown, according to some embodiments. The first exercise equipment 100 can be used as a unit of fitness equipment and/or physical therapy equipment. The first exercise equipment 100 includes a base platform 102, a first stanchion 104 extending vertically from the base platform 102 proximate a first end of the base platform 102, a second stanchion 106 extending vertically from the base platform 102 proximate the first end of the base platform 102, a display console 108 coupled to the base platform 102 and positioned between the first stanchion 104 and the second stanchion 106. The exercise apparatus can also include a bench selectively positionable on the base platform 102. The first exercise equipment 100 also includes a first motor 112 positioned on the base platform 102 at the first stanchion 104 and a second motor 114 positioned on the base platform 102 at the second stanchion 106.

The first exercise equipment 100 can also include a first cable extending from the first motor 112 and a second cable extending from the second motor 114. The first exercise equipment 100 also includes a first terminal 122 coupled to the first stanchion and repositionable along the first stanchion 104, and a first set of pulleys 123 positioned at the base platform 102. In the state shown in FIG. 1, the first cable can extend from the first motor 112 along the first set of pulleys 123 to the first terminal 122, for example. Cable routing according to some embodiments is shown in U.S. Patent Application No. 17/495,584, filed Oct. 6, 2021, the entire disclosure of which is incorporated by reference herein in its entirety.

The first exercise equipment 100 also includes a second terminal 124 coupled to the second stanchion 106 and repositionable along the second stanchion 106, and a second set of pulleys 125 positioned at the base platform 102. In the state shown in FIG. 1, the second cable can extend from the second motor 114 along the second set of pulleys 125 to the second terminal 124, for example. Cable routing according to some embodiments is shown in U.S. Patent Application No. 17/495,584, filed Oct. 6, 2021, the entire disclosure of which is incorporated by reference herein in its entirety.

As shown in FIG. 1, the base platform 102 is substantially planar and is configured to stably rest on a floor or other ground surface to provide a stable foundation for the exercise apparatus 100. The base platform 102 can define an exercise surface on which a user can perform one or more exercise and/or on which the bench 110 can be positioned. In some embodiments, the base platform 102 is configured to be at least partially foldable into an out-of-use configuration in which the base platform 102 is folded up and away from the floor or ground under the base platform 102 (thereby reducing the space occupied by the first exercise equipment 100 when not in use). The base platform 102 can include one or more sensors configured to detect user interactions with the base platform 102, for example one or more force sensors, pressure sensors, load cells, accelerometers, acoustic sensors (microphones), etc. For example, the base platform 102 may include one or more force plates coupled to a frame of the base platform 102 so as to be slightly moveable, enabling the one or more force plates to measure (e.g., weigh) forces and/or pressures exerted thereon and/or accelerations thereof (e.g., caused by a user).

The display console 108 may be configured to display information relating to operation of the first exercise equipment 100 to a user. As shown in FIG. 1, the display console 108 includes a screen 140 (e.g., LED screen). In some embodiments, the screen 140 is a touchscreen configured to accept user input. In other embodiments, one or more additional buttons, keys, toggles, etc. are included on the display console 108 to receive user input. In some embodiments, the display console 108 includes one or more speakers configured to emit sounds relating to operation of the exercise apparatus 100. In some embodiments, the first exercise equipment 100 alternatively or additionally includes a virtual reality or augmented reality headset configured to be worn by a user and to display information relating to operation of the first exercise equipment 100 to the user. In some embodiments, the display console 108 houses a controller for the exercise apparatus 100.

The first stanchion 104 and the second stanchion 106 extend upwards from the base platform 102 and are spaced apart from one another near an end of the base platform 102. The first stanchion 104 and the second stanchion 106 are shown as being substantially symmetric across a center line of the base platform 102. As shown in FIG. 1, the first stanchion 104 and the second stanchion 106 are substantially the same height. The first stanchion 104 and the second stanchion 106 may be approximately six feet tall, for example with a height in a range between five feet and seven feet, as in the example of FIG. 1. In other embodiments, the first stanchion 104 and/or the second stanchion 106 may be shorter, for example with a height in a range between two feet and four feet.

The first terminal 122 is coupled to the first stanchion 104 and is configured to be selectively repositioned along the first stanchion 104. For example, the first terminal 122 may include a projection that rides along a groove or slot of the first stanchion 104 (or vice-versa) and can be selectively held in place at various heights using a pin configured to engage apertures of the first stanchion 104. The first terminal 122 can include a handle to facilitate repositioning of the first terminal 122. The second terminal 124 is coupled to the second stanchion 106 and is configured to be selectively repositioned along the second stanchion 106. For example, the second terminal 124 may include a projection that rides along a groove or slot of the second stanchion 106 (or vice-versa) and can be selective held in place at various heights using a pin configured to engage apertures of the second stanchion 106. The second terminal 124 can include a handle to facilitate repositioning of the second terminal 124. Accordingly, the first terminal 122 and the second terminal 124 can be repositioned (e.g., manually by a user) to various heights along the first stanchion 104 and the second stanchion 106, i.e., at various heights above the base platform 102. In some embodiments, actuators (e.g., linear actuators) are included in the first stanchion 104 and the second stanchion 106 to automatically move the first terminal 122 and the second terminal 124, for example as described in U.S. Patent Application No. 17/584,245, filed 20 Jan. 2022, the entire disclosure of which is incorporated by reference herein.

The first motor 112 is shown as being positioned on the base platform 102 at a bottom end of the first stanchion 104. The first motor 112 can be operationally coupled to a first cable such that the first motor 112 can generate tension in the first cable. In some examples, the first motor 112 can include an electric motor coupled to a spool such that the electric motor operates to generate a torque that rotates the spool. In such examples, the spool is coupled to a first cable such that the first cable can be repeatedly wound and unwound from the spool of the first motor 112 by operation of the first motor 112.

The first motor 112 is configured to controllably generate a force that acts both acts to retract a first cable towards the first motor 112 and to resists the first cable from being pulled out (unspooling, releasing) from the first motor 112. Thus, the first motor 112 can provide a controllable tension in the first cable in different phases (e.g., concentric and eccentric phases) of exercises performed using the exercise apparatus 100, for example providing different amounts of tension in different phases or otherwise dynamically altering the tension. In some embodiments, the first motor 112 includes a permanent magnet direct current motor. In various embodiments, the first motor 112 includes a belt, a gear, a set of gears, various gearing, etc.

The second motor 114 is shown as being positioned on the base platform 102 at a bottom end of the second stanchion 106. The second motor 114 is operationally coupled to a second cable such that the second motor 114 can generate tension in the second cable 120. Other than acting on the second cable 120 rather than the first cable 118, the second motor 114 is configured substantially the same as the first motor 112 in the examples shown. Various exercises that can be enabled by the operation of the first motor 112 and the second motor 114 are shown in U.S. Patent Application No. 17/495,584 filed Oct. 6, 2021, U.S. Patent Application No. 17/462,237 filed Aug. 31, 2021, and U.S. Patent Application No. 17/495,575 filed Oct. 6, 2021, the entire disclosures of which are incorporated by reference herein.

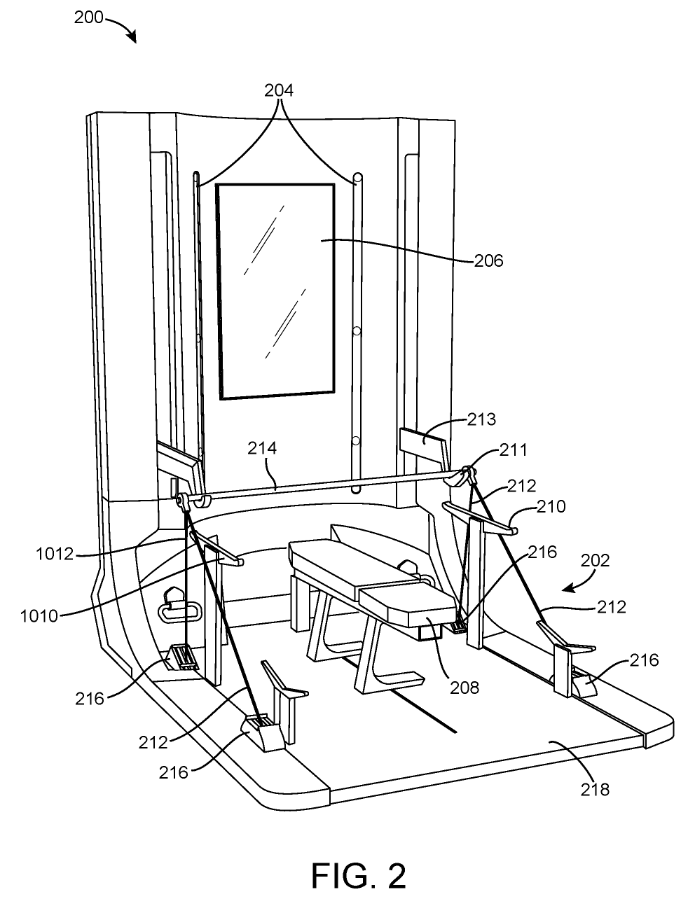

Referring now to FIG. 2, a perspective view of a another embodiment of exercise equipment (referred to herein as second exercise equipment 200) is shown, according to an example embodiment. The second exercise equipment 200 is configured to provide a full fitness experience, including a resistance training experience. In particular, the second exercise equipment 200 includes the a multi-cable force production system 202, a pacing lighting system 204, a display interface 206, an integrated bench 208, and adjustable rails 210.

The multi-cable force production system 202 can be configured as described in detail in U.S. Patent Application No. 16/909,003, filed Jun. 23, 2020, the entire disclosure of which is incorporated by reference herein. The multi-cable force production system 202 as shown here in FIG. 2 includes multiple (shown as four) cables 212 connected to a barbell 214 that can be selectively supported by cradles 211 supported by a frame 213. The cables 212 are connected to independent electric motors via separate pulleys 216. The electric motors can be operated to independently vary the tension in each cable in order to create a desired force profile at the barbell 214, as described in detail in the above-cited U.S. Patent Application No. 16/909,003.

The multi-cable force production system 202 is also shown as include platform (base, foundation, exercise surface, etc.) 218. Platform 218 can include one or more sensors configured to detect user interactions with the platform 218, for example one or more force sensors, pressure sensors, load cells, accelerometers, acoustic sensors (microphones), etc. For example, the base platform 218 may include one or more force plates coupled to a frame of the platform 218 so as to be slightly moveable, enabling the one or more force plates to measure (e.g., weigh) forces and/or pressures exerted thereon and/or accelerations thereof (e.g., caused by a user).

The pacing lighting system 204 can be configured as described in detail in U.S. Patent Application No. 17/010,573, filed Sep. 2, 2020, the entire disclosure of which is incorporated by reference herein. The pacing lighting system 204 as shown here in FIG. 2 includes a pair of vertically-arranged rows of lighting element configured to illuminate dots (points, circles, areas) of different colors. The dots illuminated on the pacing lighting system 204 can indicate to a user a desired/preferred range of motion for an exercise a real-time indication of the preferred position of the user (showing movement intended to be followed by the user), and a current position of the user (or barbell 214) relative to that range of motion. As shown in FIG. 2, the pacing lighting system 204 can be arranged parallel to a linear path along which the frame 213 can move, such that the pacing lighting system 204 can illuminate points that correspond to heights relative to the frame 213. In some cases, control of the pacing lighting system 204 and the linear positioning system for the frame 213 are coordinated so that an illuminated dot intended to guide the user’s motion is aligned with the cradles 211 at the beginning and end of an exercise.

The display interface 206 is configured to show various instructions, exercise data, resistance amounts, exercise routines, and other information to a user. The display interface 206 may be a touchscreen to enable interaction between the user and the display interface 206. For example, the display interface 206 may be configured to accept user inputs requesting operations and changing settings for the second exercise equipment 200, force production system 202, and/or pacing lighting system 204. Various customized exercise programs and content can be provided via the display interface 206, including as described in U.S. Patent Application No. 16/909,003 cited above and incorporated herein by reference.

The second exercise equipment 200 is also shown as including an integrated bench 208 which can be selectively included or removed from the second exercise equipment 200 to enable exercises suitable for performance using a bench (e.g., bench press). The integrated bench 208 may be configured to be coupled to the platform 218 in some embodiments. The integrated bench 208 can be adjustable to different inclinations for various exercises. In some embodiments, the integrated bench 208 includes sensors or electronics to facilitate use of the integrated bench with other elements of the second exercise equipment 200.

The second exercise equipment 200 is also shown as including adjustable rails 210. The adjustable rails 210 are positioned below the cradles 211 and along sides of the platform 218, and are configured to stop the bar from moving lower than height defined by the adjustable rails 210. The adjustable rails 210 can thus receive the barbell 214 when a user is unable to complete an exercise or otherwise wishes to place the barbell 214 somewhere other than in the cradles 211.

Various hardware and/or software of the various elements of the second exercise equipment 200 can be integrated and/or interoperable to provide for a comprehensive, unified experience for users of the second exercise equipment 200. For example, a control system for the second exercise equipment 200 can control the force production system 202, the pacing lighting system 204, and the display interface 206. As one feature enabled by this integration, the force production system 202 can be controlled in coordinate with motorized movement of the cradles 211 by one or more actuators (e.g., as described in U.S. Patent Application No. No. 17/584,245, filed 20 Jan. 2022, the entire disclosure of which is incorporated by reference herein), for example either allowing the cables 212 to be extended as the cradles 211 move upwards or by retracting slack in the cables 212 as the cradles 211 move downwards. Various other integrations are also possible in various embodiments.

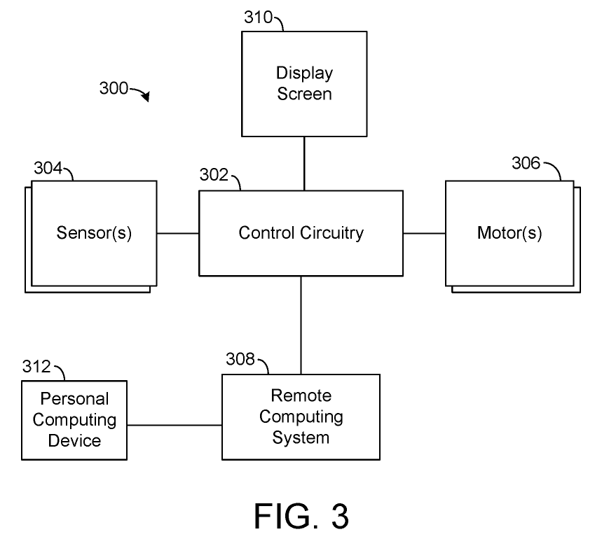

Referring now to FIG. 3, a block diagram of a control system 300 that can be included with the second exercise equipment 200 or first exercise equipment 100 is shown, according to some embodiments. The control system 300 includes control circuitry 302 that receives data (signals, information, etc.) from one or more sensors 304 and controls one or more motors 306 (e.g., first motor 112 and second motor 114 of FIG. 1, motors of multi-cable force production system 202 of FIG. 2). The control circuitry 302 is also shown as being communicable with a remote computing system 308, for example via one or more networks (e.g., Internet, intranet, WiFi, cellular network, etc.) and connected to a display screen 310 (e.g., screen 140, display interface 206, pacing lighting system 204, personal computing device, smartphone, smartwatch, AR/VR headset, etc.). The control system 300 is also shown as including a personal computing device 312 (e.g., smartphone, laptop, tablet, desktop computer) communicable with the remote computing system 308 (e.g., via the Internet).

The control circuitry 302 is configured to (e.g., programmed to, storing computer-executable instructions on non-transitory computer-readable media and including one or more processors to execute such instructions to, including software and/or firmware to) control the motor(s) 306 to cause the motor(s) 306 to provide forces (loads, tension, etc.) experienced by a user during performance of exercises using the second exercise equipment 200 or exercise apparatus 100. The control circuitry 302 is also configured to cause the display screen 310 to display graphical user interfaces providing instructions, visualizations, virtual environments, video content, etc., as may be suitable for various exercises. The control circuitry 302 can control the motor(s) 306 and display screen 310 to provide various types of strength and cardio exercises, content, and exercise-related gaming including as described in U.S. Patent No. 11,504,570; U.S. Patent No. 11,918,884, U.S. Patent Application No. 17/462,237; U.S. Patent No. 12,186,628; U.S. Patent No. 12,036,444; U.S. Patent No. 12,048,860; U.S. Application No. 18/624,292; U.S. Application No. 18/634,436; U.S. Application No. 18/634,490; and/or U.S. Application No. 18/974,446, the entire disclosures of which are incorporated herein in their entireties.

In some embodiments, the control circuitry 302 includes input ports, pins, etc. wired to the sensors 304 such that the control circuitry 302 receives electronic signals from the sensors 304. The control circuitry 302 can also input outlet ports, pins, etc. conductively connected to the one or more motors 306 to control the one or more motors 306. In some embodiments, the control circuitry 302 includes memory and processing components (e.g., one or more memory devices and one or more processors) programmed to execute operations described herein.

The one or more sensors 304 can include one or more types of sensors in various embodiments. The one or more sensors 304 may be positioned at an exercise surface on which a user’s foot (or feet) will be placed during an exercise (e.g., ground, floor, platform 102, base 218). In some embodiments, the one or more sensors 304 are integrated with the platform 102 of the first exercise equipment 100 of FIG. 1 or the base 218 of the second exercise equipment 200 of FIG. 2. In other embodiments, a mat, surface, etc. including force sensors is provided mechanically separate from (e.g., other than communication connection to control circuitry 302), for example in embodiments where the platform 102 or base 218 is omitted. In other embodiments, the one or more sensors 304 are provided in wearable device, for example integrated into footwear or provided in a pod that can be attached to a user’s footwear. The one or more sensors 304 are thus arranged to measure results of actions of the user’s foot or feet.

In some embodiments, the one or more sensors 304 include one or more force sensors configured to measure a force or pressure (and/or detect changes in force or pressure). The one or more force sensors can include one or more load cells (e.g., piezoelectric load cells, inductive load cells, capacitive load cells, etc.), scales, strain gauges, force sensing resistor, fiber optic force sensor, and/or other type of force sensor in various embodiments. The one or more force sensors are configured to output data (e.g., digital information, analog signal, etc.) indicative of a force or pressure exerted on the sensor, for example a force or pressure provided by a user on the sensor (e.g., by tapping of the user’s foot or feet).

In some embodiments, the one of more force sensors are positioned in a base of fitness equipment, for example in platform 102 of FIG. 1 or base 218 of FIG. 2. In some embodiments, force sensors are arranged or distributed so as to detect forces across a large surface area of the platform 102 or base 218. In some embodiments, the platform 102 or base 218 includes a force plate configured such that forces on the force plate are mechanically transferred to at least one of the one or more sensors 304. For example, a force plate may be positioned over one or more sensors 304 and moveable, at least slightly, relative to a frame of the platform 102 or base 218 so that the force plate can communicate force from a user to the one or more sensors 304. The force plate may be configured as a scale (e.g., electronic/digital scale) such that the force plate enables production of data indicative of forces (or changes therein) or on the platform 102 or base 218.

In some embodiments, the one or more sensors 304 include one or more accelerometers (e.g., piezoelectric accelerometers, piezoresistance accelerometers, capacitive accelerometers). An accelerometer provides data indicative of acceleration of the accelerometer. In some embodiments, one or more accelerometers are positioned at or in the platform 102 or base 218 and can measure movement associated with slight flexing or displacement of part of the platform 102 or base 218 under forces exerted from a user, including in some embodiments flexing or displacement that is imperceptible by the user, for example caused by tapping of the user’s foot on the platform 102 or base 218. In other embodiments, one or more accelerometers can be provided in a wearable device (e.g., foot pod, watch, headband).

In some embodiments, the one or more sensors 304 measure movement of the motor(s) 306 and/or of a cable, spool, or other structure coupled to the motor(s) 306. For example, the sensors 304 can measure an amount of movement of a cable coupled to a motor 306 and/or a force exerted on the cable, in various embodiments.

The one or more sensors 304 can thereby provide data to the control circuitry 302 relating to user performance, for example a user’s balance symmetry, mobility, and/or strength, exhibited by the user during performance of exercises using the first exercise equipment 100 or second exercise equipment 200.

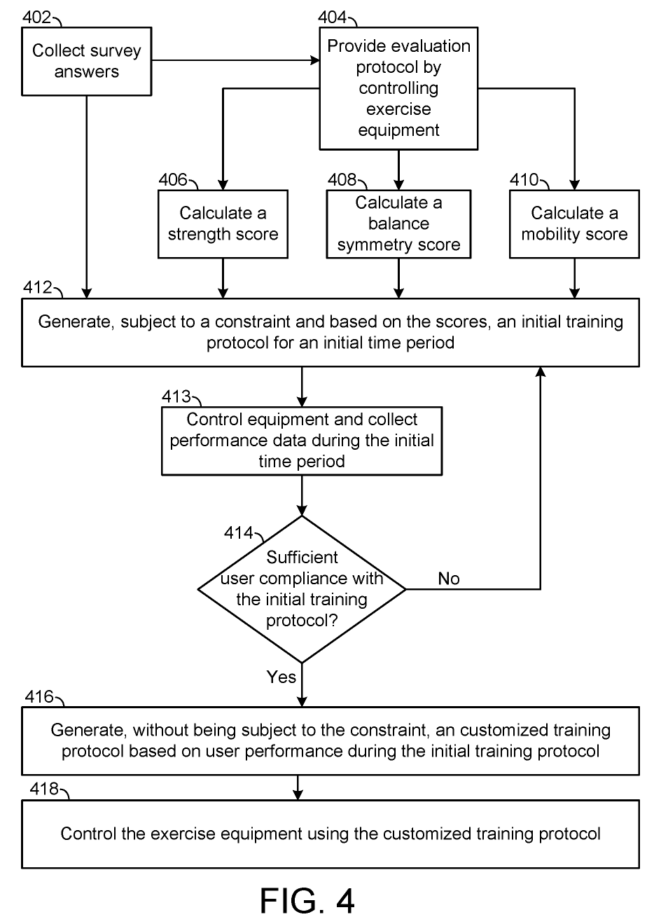

The remote computing system 308 can be a cloud-computing resource or other server or computing system, located remotely from the control circuitry 302 and motor(s) 306. The remote computing system 308 is configured to receive data on system operations and user performance from the control circuitry 302, for example sensor measurements, metrics or scores generated based on the sensor measurements, forces exerted by the motor(s), a history of exercises provided by the control circuitry 302, and/or other data in various embodiments. The remote computing system 308 can also provide exercise, video content, gaming content, interactivity between different units of the first exercise equipment 100 or the second exercise equipment 200, and/or other functionality in various embodiments. In some embodiments, the remote computing system 308 provides automated training protocol generation, as described below with reference to FIGS. 4-13.

The personal computing device 312 is communicable with the remote computing system 308 and can execute an application associated with interacting with the remote computing system 308 and/or provide web- or browser-based access to content hosted by the remote computing system 308. The personal computing device 312 can operate to provide user interactions with the remote computing system 308, for example for user account creation and management, answering of survey questions, viewing and managing training protocols, view reports of user progress and user fitness scores (e.g., strength score, mobility score, balance symmetry score), access content including exercise videos and non-exercise content (e.g., nutrition-related content, lifestyle content, motivational coaching content), and/or otherwise provide a user with mobile access to features of the control system 300 without requiring the user to access such features via the display screen 310.

Referring now to FIG. 4, a flowchart of a process 400 is shown, according to some embodiments. The process 400 can be executed by the control system 300 provided with the first exercise equipment 100 or second exercise equipment 200, in various embodiments. For example, the process 400 can be executed by the remote computing system 308, the control circuitry 302, and/or any combination thereof. The process 400 relates to providing a user with a user-specific training protocol to facilitate fitness progress for the user of the first exercise equipment 100 or the second exercise equipment 200. Process 400 can be initiated when a user selects, via the personal computing device 312 or the display screen 310 to enter a training protocol generation mode or otherwise requests that the control system 300 generate a training protocol for the user.

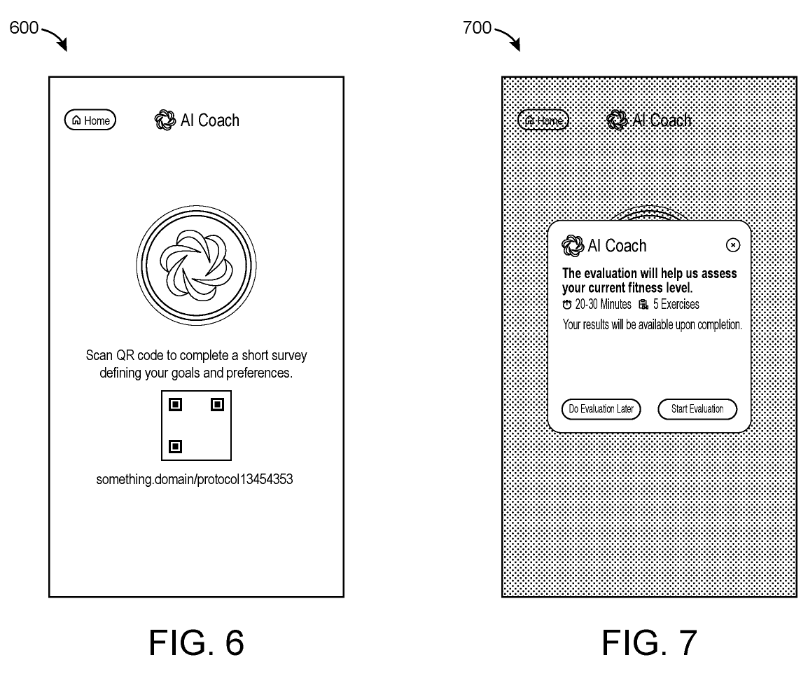

At step 402, survey answers are collected, for example from the user. Collecting survey answers in step 402 can include providing, from the remote computing system 308 to the personal computing device 312, a list of survey questions. In some embodiments, step 402 includes presenting a link or QR code on the display screen 310 (for example as shown on graphical user interface 600 of FIG. 6) which can be used by the personal computing device 312 to access survey questions to be displayed to and answered by the user. The survey questions and answers can relate to experience level (e.g., with strength training, exercise, fitness, etc.), training goals (e.g., selectable between weight loss, muscle gain, strength gain, sport-specific performance, etc.), areas of the body exercises should avoid (e.g., due to user injury or preference), preferred length of training sessions, and other user information such as height, weight, gender, etc. Survey answers can be collected via the personal computing device 312 and stored in the remote computing system 308.

At step 404, an evaluation workout is provided, for example by controlling the exercise equipment (e.g., first exercise equipment 100 or second exercise equipment 200) to provide a user with a set of exercises while collecting data on user performance. The evaluation workout can include a workout including several exercises, for example five exercises for which the user performs three sets of each exercise. The evaluation workout may contain associated videos that provide the user with instruction on how to perform the exercises properly. The display screen 310 and motors 305 can be controlled by the control circuitry 302 to instruct the user to carry out the exercises and provide forces experienced by the user during the exercises. In some embodiments, step 404 is initiated by a user selection to start the evaluation via the graphical user interface 700 shown in FIG. 7, as displayed on display screen 310, as an example embodiment.

The exercises provided in the evaluation workout can include increasing and/or otherwise adapting forces and/or other degree of difficulty through the sets of each exercise (e.g., between sets, within sets) in order to explore the user’s performance limits. In some embodiments, the exercises are automatically selected based on answers to the survey, for example to exclude exercises targeting body parts that the user indicated to avoid (e.g., providing only upper body exercises if user indicated to avoid lower body exercises due to a knee injury or the like), to adapt to user experience level (e.g., providing more complex weight training exercises if the user indicated the user is an experienced with strength training and providing simpler exercises if the user indicated less experience), or otherwise adapt to user inputs. Step 404 can include collecting data from one or more sensor(s) and/or from motor(s) 306 indicating user balance symmetry (e.g., based on force plate measurements), range of motion (e.g., based on movement of the motors and/or other tracking of the user), and strength (e.g., based on torque created by or on the motors during performance of the exercises).

As shown in FIG. 4, process 400 can include calculating multiple scores relating to user fitness and performance based on completion of (e.g., results of, user performance measured during) the evaluation workout of step 404. The example of FIG. 4 shows the process 400 as including calculating a strength score at step 406, calculating a balance symmetry score at step 408, and calculating a mobility score at step 410.

In some embodiments, step 406 includes calculating the strength score based on a maximum or total amount of weight (or other measure of force, load, tension, etc.) moved by the user during one or more exercises of the evaluation workout of step 404. For example, in some scenarios, three sets of each of multiple exercises are provided in the evaluation procedure, and data from the third set for each exercise (e.g., weight moved in the third set, number of reps achieved in the third set, etc.) is used for calculating the strength score in step 406 (while discarding the data from the other sets). The strength score may be calculated by calculating a one-rep max weight for each exercise of the evaluation workout (based on measured performance) and taking a normalized average of the one-rep maximums. The normalized average may be normalized relative to a database of user performance of other users (e.g., such that the strength score is scaled relative to other users of other instances of the fitness equipment and exercise apparatuses here). For example, the exercise score can be provided as a value between 0 and 1000 (or between 100 and 1000).

In some embodiments, step 408 includes calculating the balance symmetry score based on data indicating how well the user is able to balance, between the left and right sides of the user, the forces experienced by and exerted by the user during the exercise of the evaluation workout. Data used in calculating the balance symmetry can include force plate data (e.g., data from platform 102 or 218 such as independent force measurements for the user’s right foot and left foot) and data from the motor(s) or otherwise relating to forces on the motor(s) (e.g., data indicating a user is pushing harder with their left hand than their right hand or vice versa). Calculating the balance symmetry score can include determining an average deviation from perfect balance for exercise in the evaluation workout (e.g., determining an average weight in the user’s right foot is 95% of the average weight in the user’s left foot) and normalizing the average deviation relative to a scale of possible values (e.g., a perfect score if perfectly balanced, a lowest score at 80% or at a value determined based on a large set of prior user data and/or dynamically changing with collection of user data). The balance symmetry score may be provided in the same range as the strength score, for example in a range between 0 and 1000 (or between 100 and 1000)

In some embodiments, step 408 includes calculating the mobility score based on range of motion data collected during the evaluation workout. In some embodiments, each exercise in the evaluation workout is associated with an ideal range of motion (e.g., as a function of a height of a user, in units of distance). Step 408 can then include comparing an actual range of motion achieved by a user during the exercise (e.g., by tracking unspooling of cables via sensors proximate the motors, by tracking a user movement with a camera, tracking user movement with an accelerometer, etc.). An average ratio of actual range of motion to ideal range of motion can be used to determine the mobility score, for example normalized to the same range as the strength and balance symmetry score of 0 and 1000 (or between 100 and 1000). In some embodiments, the strength score, the balance symmetry score, and the mobility score are presented to a user following steps 406-408, for example via the display screen 310 or the personal computing device 312.

At step 412, an initial training protocol for an initial time period is generated. The initial training protocol can be generated based on the strength score, the balance symmetry score, and/or the mobility score, and/or based on the survey answers from step 402. The initial training protocol can also be generated subject to a heuristic constraint, for example a heuristic constraint ensuring that the initial training protocol follows a set of expert-defined rules or heuristics for providing an initial training protocol. Such heuristic constraints can provide guidance on combinations of exercises to performed together (or not perform together), schedules of workouts across multiple days to balance full-body load, or other general guidelines to be follows in generating an initial training protocol. For example, a heuristic constraint may require that the initial training protocol include at least a predefined set of exercises or include at least one exercise selected from each of multiple categories of exercises (e.g., categories associated with different muscle groups). As another example, a heuristic constraint may prevent certain exercises from being provided in the same workout or in subsequent workouts (e.g., on consecutive days) (e.g., such that the user is not presented with instructions to perform lunges two days in a row, such that the user is not presented with a workout session consisting of several types of lunges, preventing selection of multiple isolation exercises for the same muscle group at high frequency in a workout plan). As another example, a heuristic constraint may require that a number of reps and/or sets be in a predefined range, etc. In some embodiments, the heuristic constraint is provided as a template initial workout protocol (e.g., expert-defined) which can then be morphed in step 412 along allowed degrees of freedom for the particular user based on survey answers and/or data collecting on the user’s performance of the evaluation protocol (e.g., allowing adjusting of weight loads, rep numbers, set numbers and/or adding or removing certain exercises while still taking the user through at least approximately the combination of exercises in the template workout protocol).

An artificial intelligence model (e.g., generative large language model fine-tuned to generate training protocols) or other algorithm or model for automated training protocol generation can be used in step 412; advantageously, constraining such algorithm or model to comply with a heuristic constraint during the initial training protocol can provides several benefits, including: (i) building user trust in training protocol generation as users may expect to see an initial training protocol track expert recommendations and heuristics; (ii) ensuring that that the initial training protocol provides sufficient opportunity for data collection on user performance that can enable non- or less-constrained training protocol generation after the initial training period; (iii) causing the initial training protocol to demonstrate to the user a full range of equipment capabilities and to facilitate the user in learning how to use the equipment in a full range of available configurations; and (iv) allowing time for a user to become accustomed to use of the first exercise equipment 100 or second exercise equipment 200. The advantages can contribute to collection of rich, reliable data (e.g., exploring full user and system dynamics, avoiding noise associated with user learning on how to use the equipment, etc.) for model training and/or for use in customization for a particular user, as described below.

The initial training protocol can be provided for an initial training period, for example multiple weeks (e.g., two weeks, three weeks, four weeks, five weeks, etc.). Step 413 can be provided during the initial training period, in particular by controlling fitness equipment (e.g., exercise apparatus 100, exercise apparatus, motor(s) 306, display screen 310) in accordance with the initial training protocol. For example, the initial training protocol can indicate that a particular exercise should be performed at a particular weight by the user, and step 413 can include automatically controlling the motor(s) 306 to exert a corresponding force while the user completes the exercise. Step 413 can then include automatically adjusting the force to a level indicated for a next exercise of the initial training protocol. Step 412 can be executed during multiple workout sessions during the initial training period (e.g., once a day, a few days a week, etc.).

At step 414, a determination is made as to whether the user sufficiently complied with the initial training protocol. For example, a determination can be made as to whether the user completed greater than a threshold percentage of the workouts or exercises prescribed by the initial training protocol (e.g., greater than 65% of the workouts). If not, process 400 returns to step 412 where an initial training protocol is generated again, for example based on any updates that may be appropriate to the strength, balance symmetry, and mobility scores due to portions of the initial training protocol that were completed and/or based on an adjusted survey answers (e.g., in response to prompting a user to indicate why they did not complete the workouts). Abstaining from proceeding beyond the initial training protocol if the user did not sufficiently comply with the initial training protocol can enforce the advantages of the initial training protocol described above.

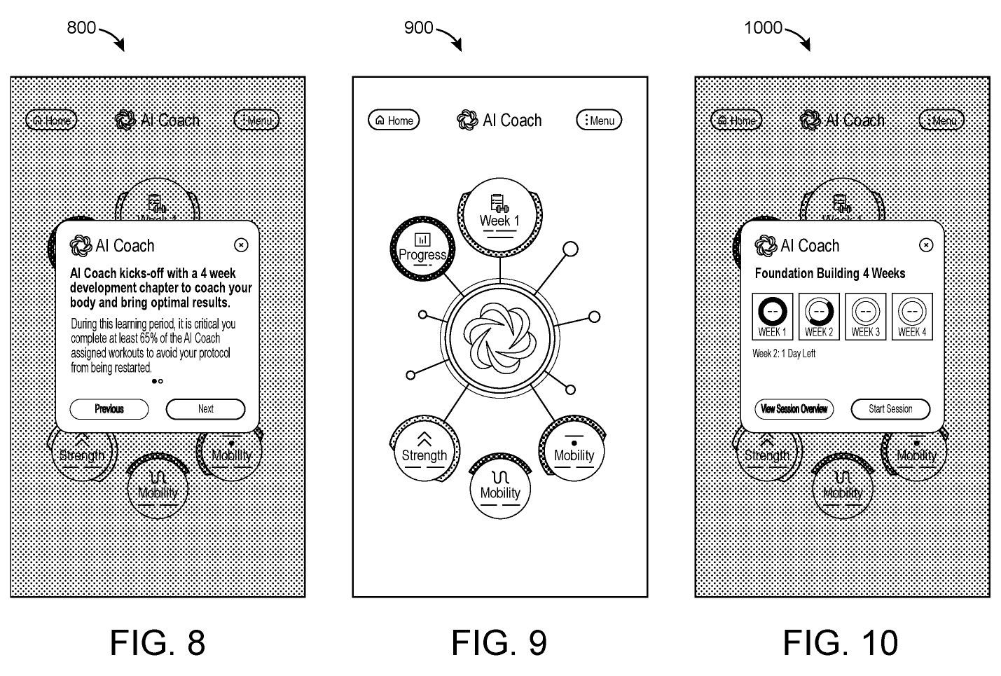

Providing the initial training protocol can include providing user interfaces via the display screen 310 showing the user’s progress through the initial training protocol. Such interfaces can include interface 800 of FIG. 8 providing general instructions relating to the initial training protocol, interface 900 of FIG. 9 providing a graphical representation of progress through the initial training protocol together with the users strength, balance symmetry, and mobility scores, and interface 1000 of FIG. 10 providing another view showing how far the user has made it through the initial training protocol.

If the user sufficiently complied with the initial training protocol (e.g., completed greater than a threshold number of workouts in the initial training protocol), process 400 process to step 414 where a customized training protocol is generated based on user performance during the initial training protocol. Step 414 can be performed without requiring compliance with the heuristic constraint enforced in step 412. That is, automated training protocol generation in step 416 can have more freedom to customized a training protocol based on a particular user’s performance data (e.g., the user’s strength, balance symmetry, and mobility scores), survey answers, or other information, as compared to generation of the initial training protocol in step 412. Advantageously, for example, customized training protocol generation in step 412 can be based on rich user performance data collected via user compliance with the initial training protocol which may be constrained to cause the workouts completed by the user to explore a full range of the user’s fitness (e.g., various muscle groups, high- and low-rep workouts, cardio and strength exercises, etc.), to obtain a robust dataset on user baseline performance (as well as user improvement across the initial training protocol).

Step 416 may thus include generating combinations of exercises, series of workouts, other content recommendations (e.g., recommendations to view nutrition-related content, recommendations to view motivational coaching content, recommendations to view mindfulness content, recommendations for yoga or stretching workouts that do not involve physical use first exercise equipment 100 or second exercise equipment 200, recommendations for running, walking, hiking, cycling, or other outdoor activities, etc.) which may not have complied with the heuristic constraint used in step 412.

Step 418 includes controlling exercise equipment using the customized training protocol from step 418. For example, the customized training protocol can indicate that a particular exercise should be performed at a particular weight by the user, and step 418 can include automatically controlling the motor(s) 306 to exert a corresponding force while the user completes the exercise. Step 418 can then include automatically adjusting the force to a level indicated for a next exercise of the customized training protocol. Steps 416 and 418 can be executed iteratively and indefinitely as the user continues to execute workouts included in the customized training protocol. Such workouts will adapt to changes in user fitness (e.g., strength, balance symmetry, mobility) over time.

In some embodiments, iteratively executing steps 416 and 418 includes generating the customized training protocol in a manner adapted to drive the training protocol towards a target muscle distribution for the user, based on tracked user exercise performance during performance of exercises using the first exercise equipment 100 or second exercise equipment 200. For example, as described in detail in U.S. Application No. 19/384,417, the entire disclosure of which is incorporated by reference herein, steps 416 and 418 can include obtaining a target muscle distribution for a workout plan (e.g., determined for the user based on survey answers), tracking a muscle distribution of a user activated by the exercises actually performed by the user (which may differ from exercises prescribed to the user in the workout plan if the user skips exercises, does extra sets, increases or decreases weight, etc.), and selecting future exercises for the workout plan by optimizing a similarity of the muscle distribution of the user activated by the exercises and the target muscle distribution. In such an approach, tracking and optimizing muscle distribution can include obtaining a first muscle distribution vector comprising values for a plurality of muscle groups representing amounts of activation of the plurality of muscle groups by a first exercise of the exercises, scaling the first muscle distribution vector based on a number of repetitions of the first exercise performed by the user, and combining the first muscle distribution vector with additional muscle distribution vectors associated with additional exercises performed by the user. Such an approach advantageously allows for automated realignment over time of the training protocol with the user’s goals for training of different muscle groups (e.g., based on different fitness, sports performance, health, rehab, aesthetic, or other goals of the user).

In some embodiments, iteratively executing steps 416 and 418 includes adapting a training protocol and providing exercises based on automated fatigue detection during performance of exercises using the first exercise equipment 100 or second exercise equipment 200. For example, as described in detail in U.S. Patent Application No. 19/384,394, the entire disclosure of which is incorporated by reference herein, steps 416 and 418 can include collecting kinematic timeseries data relating to use of the first exercise equipment 100 or second exercise equipment 200 by a user, applying the kinematic timeseries data to a model that outputs a fatigue state of the user, and adapting operation of the first exercise equipment 100 or second exercise equipment 200 based on the fatigue state. Adapting the operation of the first exercise equipment 100 or second exercise equipment 200 based on the fatigue state can include adjusting a customized workout protocol (e.g., tuning a level of fatigue achieved during the workout protocol to optimize training stimulus without over-training) and/or in real-time to increase or decrease load (or offload) during a set based on detected fatigue state. Automated fatigue detection can be used in steps 416 and 418 to advantageously tune operations based on the physical fatigue (and thus training stimulus) experienced by a particular user.

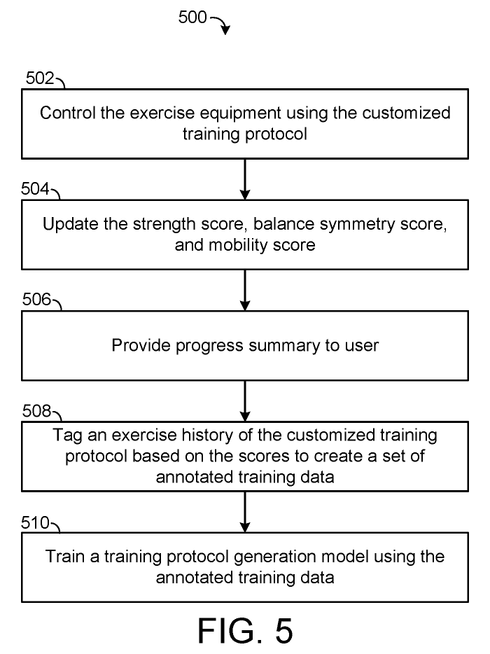

Referring now to FIG. 5, a flowchart of a process 500 is shown, according to some embodiments. The process 500 can be executed by the control system 300 provided with the first exercise equipment 100 or second exercise equipment 200, in various embodiments. For example, the process 500 can be executed by the remote computing system 308, the control circuitry 302, and/or any combination thereof. The process 500 relates to providing a user with a user-specific training protocol to facilitate fitness progress for the user of the first exercise equipment 100 or the second exercise equipment 200. The process 500 can be executed starting from the end of process 400 and/or as part of iteratively providing steps 416-418, according to some embodiments.

At step 502, exercise equipment (e.g., exercise apparatus 100, second exercise equipment 200) is controlled using a customized training protocol. For example, step 502 can be implemented as described above for step 418. While the example of process 500 shown in FIG. 5 refers to the customized training protocol of steps 416 and 418, process 500 can also be used for or together with providing the initial training protocol as in steps 412-413.

At step 504, the strength score, balance symmetry score, and mobility score can be updated for a user. In some embodiments, step 504 is executed periodically (e.g., weekly, daily, every three days, every third workout, every fifth workout). In some embodiments, step 504 is executed each time a user completes a workout. Updating the strength score, balance symmetry score, and mobility score in step 504 can include calculating new scores based on the most recent period of data (e.g., data since a previous time at which the scores were calculated or updated) and calculating a weighted average of the new scores and previous scores calculated at the previous time (e.g., such that the previous scores is weighted at 80% and the new score is weighted at 20%). Calculation of the scores based on most recent performance data together with the user’s previous scores provides the scores with inertia and prevents the scores from being over-influenced by relatively small amounts of activity.

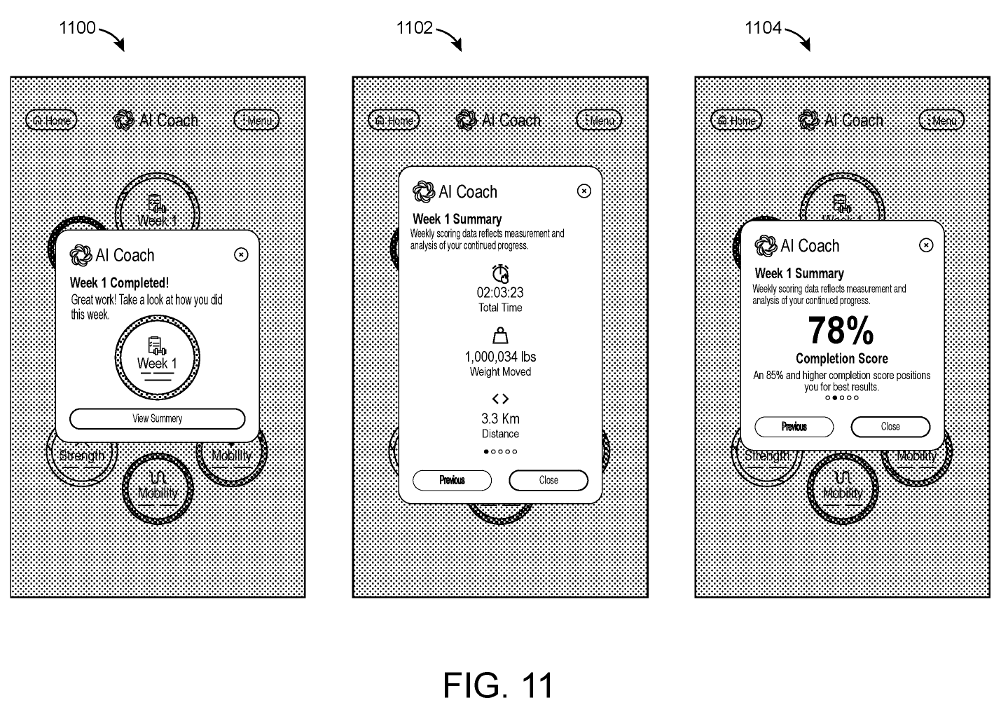

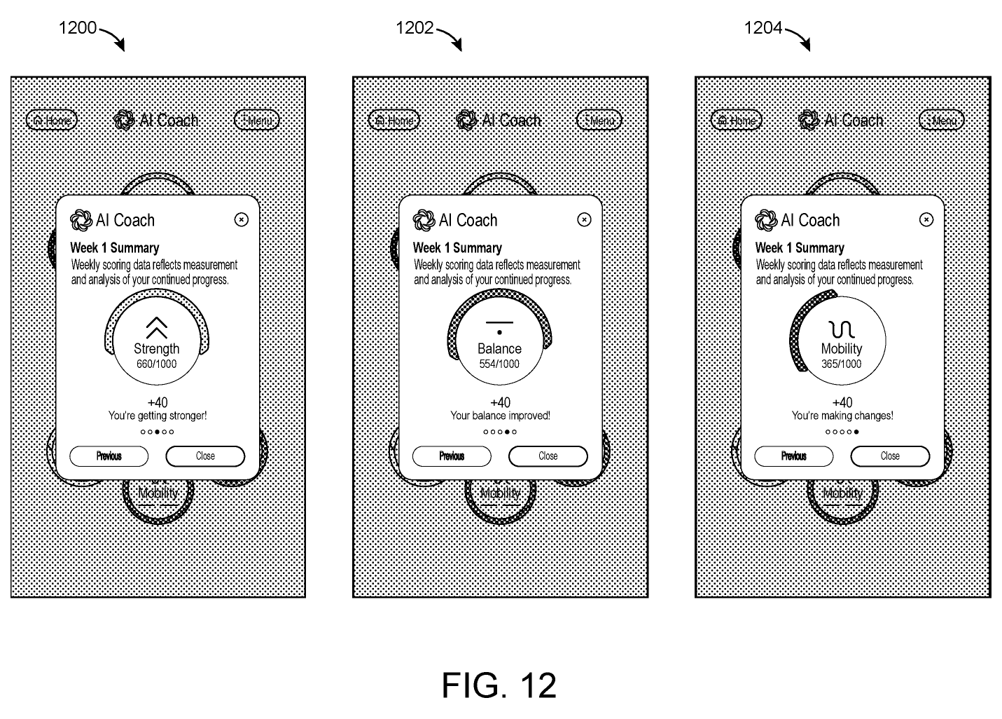

At step 506, a progress summary can be provided to a user. An example progress summary is shown in FIGS. 11-12, via the combination of user interfaces shown there which can be displayed on display screen 310 or on personal computing device 312. As shown in FIG. 11, the progress summary can include a first interface 1100 indicating that a week (or other time period) of training has been completed, a second interface 1102 shown a total training time, a total weight moved, and a total distance covered during the time period, and a third interface 1104 showing a completion score for the time period (e.g., a percentage of the assigned exercises from the training protocol for the time period which were completed by the user. As shown in FIG. 12, the progress summary can also include a fourth interface 1200 showing the user’s strength score (and the change in that score caused by the update of step 504), a fifth interface 1202 showing the user’s balance symmetry score (and the change in that score caused by the update of step 504), and a sixth interface 1204 showing the user’s mobility score (and the change in that score caused by the update of step 504). The user can thereby see an overview of the progress (or regression) of the user over the time period summarized by the progress summary.

At step 508, an exercise history of the customized training protocol is tagged based on the scores (e.g., based on changes in the scores) to create a set of annotated training data. Changes in the strength score, balance summary score, and mobility score are representative of measured changes in user fitness in those categories which can be correlated with (and potentially caused by) the training protocols provided for a user. Tagging workouts completed by a user (and also, in some embodiments, workouts in the training protocol skipped by a user) with the scores or changes in the scores provides labelling of raw workout history data with labels/tags which can provide quantitative representation of changes in user fitness. For example, a collection of workouts for a time period may be tagged with changes in strength score, mobility score, and balance summary score over the time period, and added to a data set of training data in step 508. Such tagged data can be stored together in associated with particular user information (survey answers, prior scores, demographic information, etc.).

At step 510, a training protocol generation model is trained using the annotated training data from step 508. Because the annotated training data from step 508 can provided quantitative data relating changes in user fitness associated with detailed exercise data on user workout and user performance during those workouts can thus be generated via process 500, such annotated training data can be well suited for use in a machine learning protocol, especially when steps 502-508 are executed for a large number of users. In some embodiments, for example, a machine learning model can be trained on such annotated training data to predict changes in strength, balance symmetry, and mobility scores associated with a potential training protocol to be provided to a user with a set of initial characteristics. Such a model can then be used to check (test, simulate, etc.) a set of potential training protocols (potentially, a large number of potential training protocols) to select a training protocol with the highest predicted increase in the user’s strength, balance symmetry, and mobility scores. An algorithm using said model and evaluation of potential training protocols for a given user can then be deployed in step 412 (subject to the heuristic constraint) and/or step 416 of process 400 for automated training protocol generation adapted to a particular user.

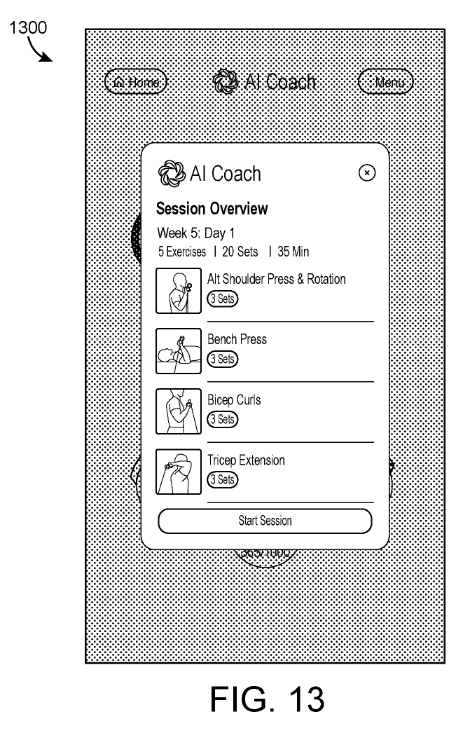

As an example of a training protocol that can be generated using such an algorithm, for example, FIG. 13 shows a graphical user interface 1300 (e.g., provided via display screen 310) which shows a workout session for a current day (shown as Week 5: Day 1). As shown in FIG. 13, the graphical user interface 1300 provides a visualization of the exercises to be completed during the workout session, for example showing a combination of four exercises and the number of sets to be performed for each exercise. The number of reps, weight, and/or other settings or goals can also be displayed, depending on the workout indicated by the training protocol. While the example of FIG. 13 shows a set of strength training exercise, the workout for a given day as provided by the training protocol can include various cardio exercises (e.g., rowing, ski-erg, kayaking), workout-based gaming (e.g., exercises integrated with a golf simulation, kayak racing, ski racing), instructor-led workout videos, non-workout content (e.g., nutrition education videos, mindfulness training videos), and or various other exercises and features that can be provided by the first exercise equipment 100 or the second exercise equipment 200 according to various embodiments (and according to the various patents and patent applications incorporated by reference herein).

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of function. One or more of various types of processors can be provided with such computer-readable media for executing the various tasks, operations, functions, etc. described herein.

What is claimed is:

1. Fitness equipment, comprising:
a motor;
a cable coupled to the motor;
an exercise implement configured to be coupled to the cable; and
a control system configured to control the motor to exert a force on the exercise implement via the cable in accordance with:
an evaluation workout;
an initial training protocol for a plurality of weeks, the initial training protocol generated by the control system based on (i) user performance during the evaluation workout and (ii) a heuristic constraint; and
a customized training protocol after the plurality of weeks, the customized training protocol generated by the control system without requiring compliance with the heuristic constraint.

2. The fitness equipment of claim 1, wherein the control system is configured to generate the evaluation workout or the initial training protocol based on user answers to a survey.

3. The fitness equipment of claim 1, wherein the control system is configured to abstain from generating the customized training protocol in response to determining that the user completed less than a threshold amount of the initial training protocol.

4. The fitness equipment of claim 1, wherein the control system is programed to generate the initial training protocol by selecting exercises to include in the initial training protocol limited by a rule defined in the heuristic constraint.

5. The fitness equipment of claim 4, wherein the rule requires selection of at least one exercise from a first category of exercises and selection of at least one exercises from a second category of exercises.

6. The fitness equipment of claim 1, wherein the control system is configured to adjust the evaluation workout based on user answers to a survey.

7. The fitness equipment of claim 1, wherein the control system comprises:
local control circuitry co-located with the motor, the cable, and the exercise implement; and
a remote computing system.

8. The fitness equipment of claim 1, wherein the control system is configured to;
calculate a strength score, a balance symmetry score, and a mobility score based on the user performance during the evaluation workout; and
update the strength score, the balance symmetry score, and the mobility score during the plurality of weeks.

9. The fitness equipment of claim 8, wherein the control system is configured to update the strength score using a weighted average of the strength score from a previous time and an new strength score based on user performance since the previous time.

10. The fitness equipment of claim 8, wherein the control system is configured to generate the customized training protocol based on the updates to the strength score, the balance symmetry score, and the mobility score.

11. The fitness equipment of claim 8, wherein the control system is further configured to generate annotated training data by tagging workout data associated with the initial training protocol or the customized training protocol with updates to the strength score, the balance symmetry score, and the mobility score.

12. The fitness equipment of claim 11, wherein the control system is further configured to train a training protocol generation model using the annotated training data; and
use the training protocol generation model to generate the customized training protocol.

13. A method of operating motorized strength training equipment, the method comprising:
controlling a motor of the motorized strength training equipment to provide an evaluation workout;
controlling, during a plurality of weeks after the evaluation workout, the motor of the motorized strength training equipment to provide an initial training protocol for the plurality of weeks, wherein the initial training protocol is automatically generated subject to a heuristic constraint and based on user performance during the evaluation workout; and
controlling, after the plurality of weeks, the motor of the motorized strength training equipment to provide a customized training protocol, wherein the customized training protocol is automatically generated without requiring compliance with the heuristic constraint.

14. The method of claim 13, wherein motorized strength training equipment comprises a cable coupled to the motor and an exercise implement configured to be coupled to the cable.

15. The method of claim 13, comprising generating the evaluation workout or the initial training protocol based on user answers to a survey.

16. The method of claim 13, comprising abstaining from generating the customized training protocol in response to determining that the user completed less than a threshold amount of the initial training protocol.

17. The method of claim 13, comprising automatically generating the initial training protocol subject to the heuristic constraint by selecting exercises to include in the initial training protocol limited by a rule defined in the heuristic constraint, wherein the rule requires selection of at least one exercise from a first category of exercises and selection of at least one exercises from a second category of exercises.

18. The method of claim 13, comprising:
determining a strength score, a balance symmetry score, and a mobility score based on the user performance during the evaluation workout; and
displaying updates to the strength score, the balance symmetry score, and the mobility score via the motorized strength training equipment during the plurality of weeks.

19. Fitness equipment, comprising:
a motor;
a cable coupled to the motor;
an exercise implement configured to be coupled to the cable; and
a control system configured to control the motor to exert a force on the exercise implement via the cable in accordance with:
an initial training protocol for a plurality of weeks, the initial training protocol generated by the control system based on user data and a heuristic constraint; and
a customized training protocol after the plurality of weeks, the customized training protocol generated by the control system based on measured user performance during the initial training protocol and without requiring compliance with the heuristic constraint.

20. The fitness equipment of claim 13, wherein the user data comprises measurements from the user’s performance of an evaluation workout.
